(19) United States
(12) Patent Application Publication
(10) Pub. No.: US 2021/0333439 A1
(43) Pub. Date: Oct. 28, 2021

(54) POLARIZER PROTECTIVE FILM AND METHOD FOR TEARING OFF SAME

(71) Applicant: Wuhan China Star Optoelectronics Technology Co., Ltd., Wuhan (CN)

(72) Inventors: Pengfei YU, Wuhan (CN); Tao SONG, Wuhan (CN); Shaokun LI, Wuhan (CN)

(21) Appl. No.: 16/479,599

(22) PCT Filed: Apr. 10, 2019
(86) PCT No.: PCT/CN2019/082135

§ 371 Date: Jul. 21, 2019

(30) Foreign Application Priority Data
Nov. 29, 2018 (CN) 201811443126.0

(51) Int. Cl. G02B 1/14; B32B 43/00; B32B 7/06

(52) U.S. Cl. CPC G02B 1/14; B32B 2307/732; B32B 7/06; B32B 43/006

(57) ABSTRACT

The present disclosure provides a polarizer protective film and a method for tearing off the same. The polarizer protective film is used for adhering to a surface of a polarizer. The polarizer protective film is provided with an extending portion protruding from the polarizer. In the polarizer protective film of the present disclosure and the method for tearing off the same, an extending portion is provided on the polarizer protective film, so that when the polarizer protective film is torn off, there is a good force bearing point to achieve the effect of tearing off the polarizer protective film at one time.

### FIELD OF INVENTION

The present disclosure relates to a field of polarizer, and particularly, to a polarizer protective film and a method for tearing off the same.

### BACKGROUND

Typically, a polarizer is attached with a protective film. In current designs, size of the protective film is the same as that of the polarizer. Therefore, when the protective film needs to be torn off during production, an adhesive pull tape must be additionally attached to a surface of the protective film, and the protective film is taken up by adhesiveness of the pull tape, thereby tearing off the protective film. However, when an assembly machine tears a protective film of a lower polarizer, the assembly machine usually cannot completely tear off the protective film at one time due to material and viscosity of the lower polarizer, or problems that a bonding area of the pull tape is not enough, an angle of pulling the pull tape is not correct, and so on, which greatly affects production capacity.

### SUMMARY OF DISCLOSURE

The present disclosure provides a polarizer protective film and a method for tearing off the same in order to solve the technical problem, in the prior art, that a protective film is difficult to be torn off and affects production capacity.

To solve the aforementioned technical problem, the present disclosure provides a polarizer protective film for adhering to a surface of a polarizer, wherein the polarizer protective film is provided with an extending portion protruding from the polarizer.

In an embodiment, the polarizer protective film has one or more corners and the extending portion is connected to one of the corners.

In an embodiment, the polarizer protective film has two long sides and two short sides, the one or more corners are formed at intersections of the long sides and the short sides, and the extending portion is disposed on one of the short sides.

In an embodiment, the extending portion protrudes from the polarizer by a length of 3 mm to 5 mm.

In an embodiment, a thickness of the polarizer protective film is 10 um-70 um.

In an embodiment, the extending portion is shaped as strip or semicircular.

The present disclosure further provides a method for tearing off a polarizer protective film, comprising the steps of: providing a tearing device and a loading platform; placing a polarizer adhered with a polarizer protective film on the loading platform, wherein the polarizer protective film is disposed on the polarizer, and the polarizer protective film is provided with an extending portion protruding from the polarizer; adhering the polarizer protective film and the extending portion to the tearing device; and tearing off the polarizer protective film from the extending portion until the polarizer protective film is completely teared off from the polarizer.

In an embodiment, the tearing device comprises: a directional wheel; a moving wheel that is movable up and down; and an adhesive tape having an adhesive surface, two ends of which are disposed on the directional wheel and the moving wheel, respectively; wherein the adhesive tape is located above the polarizer protective film, and the adhesive surface of the adhesive tape faces the polarizer protective film; before tearing off the polarizer protective film, the adhesive surface of the adhesive tape adheres to the polarizer protective film; and when tearing off the polarizer protective film, the moving wheel rises to drive the adhesive tape to move from the extending portion in a direction away from the polarizer protective film in order to completely tear off the polarizer protective film from the polarizer.

In an embodiment, the polarizer protective film has one or more corners and the extending portion is connected to one of the corners; and when tearing off the polarizer protective film, the moving wheel rises to drive the adhesive tape to move from the corner having the extending portion in a direction away from the polarizer protective film in order to completely tear off the polarizer protective film from the polarizer.

In an embodiment, a width of the adhesive tape is the same as a width of the extending portion.

The technical effect of the present disclosure is that:

In the polarizer protective film of the present disclosure and a method for tearing off the same, an extending portion is provided on the polarizer protective film and protrudes from the polarizer, so that when the polarizer protective film is torn off, there is a good force bearing point to achieve the effect of tearing off the polarizer protective film at one time while the polarizer will not be damaged, thereby improving product quality.

### BRIEF DESCRIPTION OF DRAWINGS

In order to more clearly illustrate the technical solutions in the embodiments of the present disclosure, a brief description of accompanying drawings used in the description of the embodiments of the present disclosure will be given below. Obviously, the accompanying drawings in the following description are merely some embodiments of the present disclosure. For those skilled in the art, other drawings may be obtained from these accompanying drawings without creative labor.

FIG. 1 is a structural schematic diagram of a polarizer protective film according to an embodiment of the present disclosure.

FIG. 2 is a process flow diagram of a method for tearing off a polarizer protective film according to an embodiment of the present disclosure.

FIG. 3 is a movement state diagram of a tearing device according to an embodiment of the present disclosure, mainly showing a moving direction of a moving wheel, and the moving direction is indicated by an arrow in this figure.

FIG. 4 is another movement state diagram of a tearing device according to an embodiment of the present disclosure, mainly showing a moving direction of a moving wheel, and the moving direction is indicated by an arrow in this figure.

Elements in the accompanying drawings are labeled as follows:

| | |
|---|---|
| 1 polarizer protective film; | 2 polarizer; |
| 3 tearing device; | 4 loading platform; |
| 11 extending portion; | 12 corner; |
| 13 long side; | 14 short side; |
| 31 directional wheel; | 32 moving wheel; |
| 33 adhesive tape; | 331 adhesive surface. |

### DETAILED DESCRIPTION

The technical solutions in the embodiments of the present disclosure will be clearly and completely described below in conjunction with the accompanying drawings in the embodiments of the present disclosure. It is apparent that the described embodiments are merely a part of the embodiments of the present disclosure, and not all embodiments. All other embodiments obtained by those skilled in the art based on the embodiments of the present disclosure without creative labor are within the claimed scope of the present disclosure.

In the present disclosure, the following description of the accompanying drawings and various embodiments used to describe principles of the present disclosure are intended to illustrate only and not to limit the scope of the disclosure. Those skilled in the art will appreciate that the principles of the present disclosure may be implemented in any suitably arranged system. Exemplary embodiments will be described in detail, examples of which are illustrated in the accompanying drawings. Furthermore, an example of an embodiment of the present invention will be described in detail with reference to the accompanying drawings. In the accompanying drawings, the same reference numerals indicate the same elements.

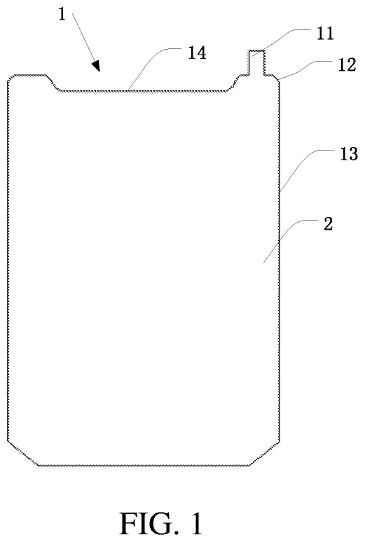

As shown in FIG. 1, the present disclosure provides a polarizer protective film 1 for adhering to a surface of a polarizer 2, wherein the polarizer protective film 1 is provided with an extending portion 11 protruding from the polarizer 2, so that when the polarizer protective film is torn off, there is a good force bearing point to achieve the effect of tearing off the polarizer protective film at one time.

The polarizer protective film 1 has one or more corners 12 and the extending portion 11 is connected to one of the corners 12. The polarizer protective film 1 has two long sides 13 and two short sides 14, the one or more corners 12 are formed at intersections of the long sides 13 and the short sides 14, and the extending portion 11 is disposed on one of the short sides 14. The extending portion 11 protrudes from the polarizer 2 by a length of 3 mm to 5 mm, a thickness of the extending portion 11 is 10 um-70 um, and the extending portion 11 is shaped as a strip or a semicircle, but is not limited thereto.

The polarizer protective film 1 may be a silicone protective film, a polyurethane (PU) protective film or an acrylic protective film, or may be a protective film of other materials, which is not specifically limited in this embodiment.

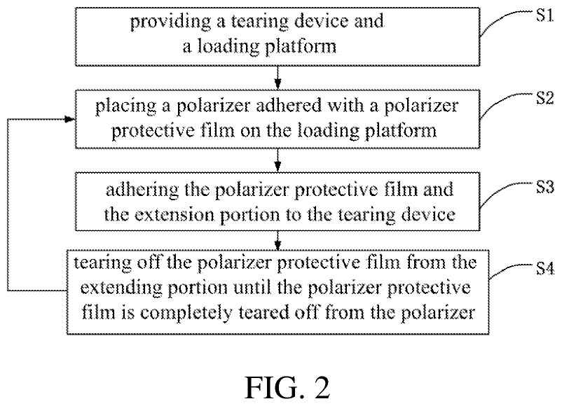

As shown in FIG. 2, the present disclosure further provides a method for tearing off a polarizer protective film 1, comprising step S1-step S4. At the same time, please refer to FIG. 1 for the structure of the polarizer protective film 1.

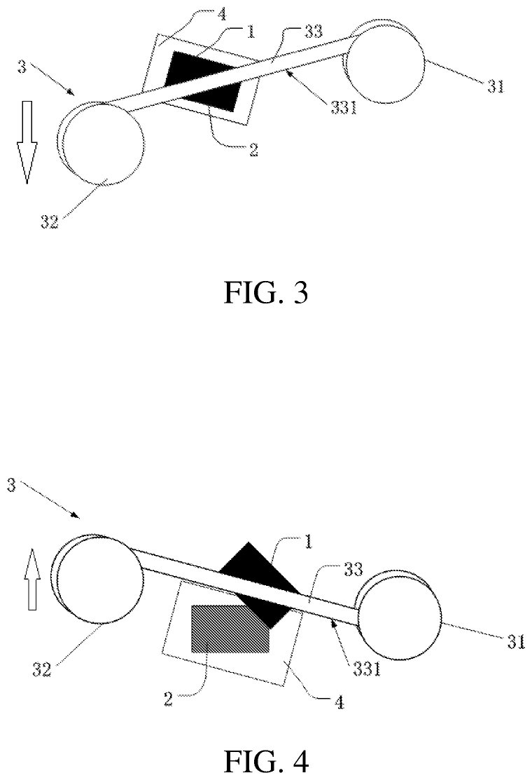

S1, providing a tearing device 3 and a loading platform 4, see FIG. 3 and FIG. 4. The tearing device 3 comprises a directional wheel 31, a moving wheel 32, and an adhesive tape 33. The moving wheel 32 is movable up and down, and two ends of the adhesive tape 33 are disposed on the directional wheel 31 and the moving wheel 32, respectively. The tearing device 3 provided in this embodiment is an existing device for tearing off the polarizer protective film 1. Therefore, other components of the tearing device 3, such as a power mechanism for moving the moving wheel 32 up and down, will not be further described herein.

S2, placing a polarizer 2 adhered with a polarizer protective film 1 on the loading platform 4, wherein the polarizer protective film 1 is disposed on the polarizer 2, and the polarizer protective film 1 is provided with an extending portion 11 protruding from the polarizer 2. The adhesive tape 33 is located above the polarizer protective film 1, and has an adhesive surface facing the polarizer protective film 1.

S3, adhering the polarizer protective film 1 and the extending portion 11 to the tearing device 3, that is, before tearing off the polarizer protective film 1, as shown in FIG. 3, the moving wheel 31 drives the adhesive tape 33 to move to a designated position at which the polarizer protective film 1 and the extending portion 11 can be adhered to the adhesive face of the adhesive tape 33.

The polarizer protective film 1 has one or more corners 12, and the extending portion 11 is connected to one of the corners 12. When tearing off the polarizer protective film 1, the moving wheel 32 rises to drive the adhesive tape 33 to move from the corner 12 having the extending portion 11 in a direction away from the polarizer protective film 1 in order to completely tear off the polarizer protective film 1 from the polarizer 12. A width of the adhesive tape 33 is the same as a width of the extending portion 11. When the extending portion 11 is attached to the adhesive tape 33, the adhesive tape 33 is aligned with the extending portion 11 as much as possible.

S4, tearing off the polarizer protective film 1 from the extending portion 11 until the polarizer protective film 1 is completely teared off from the polarizer 2. As shown in FIG. 1, in this embodiment, the polarizer protective film 1 has two long sides 13 and two short sides 14, the one or more corners 12 are formed at intersections of the long sides 13 and the short sides 14, and the extending portion 11 is disposed on one of the short sides 14. Therefore, as shown in FIG. 4, when tearing off the polarizer protective film 1, the moving wheel 32 rises to drive the adhesive tape 33 to move from the corner 12 having the extending portion 11 in a direction away from the polarizer protective film 1 in order to completely tear off the polarizer protective film 1 from the polarizer 12.

After the polarizer protective film 1 is torn off, the moving wheel 32 falls to the original designated position to perform tearing of next polarizer protective film 1.

The extending portion 11 is provided on the polarizer protective film 1, so that when a machine tears off the polarizer protective film 1, there is a good force bearing point to achieve the effect of tearing off the polarizer protective film 1 at one time while the polarizer 2 will not be damaged, thereby improving product quality.

A polarizer protective film and a method for tearing off the same, provided by the embodiment of the present disclosure, is described in detail above. It should be understood that the exemplary embodiments described herein are to be considered as illustrative only, and are intended to help in understanding the solutions of the present disclosure and its core ideas, and are not intended to limit the present disclosure. Descriptions of features or aspects in each exemplary embodiment are generally to be considered as being applicable to similar features or aspects in other exemplary embodiments. While the present disclosure has been described with reference to the exemplary embodiments, various modifications and changes can be made by those skilled in the art. The present disclosure is intended to cover such modifications and modifications within the scope of the appended claims.

What is claimed is:

1. A polarizer protective film for adhering to a surface of a polarizer, wherein the polarizer protective film is provided with an extending portion protruding from the polarizer.

2. The polarizer protective film according to claim 1, wherein the polarizer protective film has one or more corners, and the extending portion is connected to one of the corners.

3. The polarizer protective film according to claim 2, wherein the polarizer protective film has two long sides and two short sides, the one or more corners are formed at intersections of the long sides and the short sides, and the extending portion is disposed on one of the short sides.

4. The polarizer protective film according to claim 1, wherein the extending portion protrudes from the polarizer by a length of 3 mm to 5 mm.

5. The polarizer protective film according to claim 1, wherein a thickness of the polarizer protective film is 10 um-70 um.

6. The polarizer protective film according to claim 1, wherein the extending portion is shaped as a strip or a semicircle.

7. A method for tearing off a polarizer protective film, comprising the steps of:
providing a tearing device and a loading platform;
placing a polarizer adhered with the polarizer protective film on the loading platform, wherein the polarizer protective film is disposed on the polarizer, and the polarizer protective film is provided with an extending portion protruding from the polarizer;
adhering the polarizer protective film and the extending portion to the tearing device; and
tearing off the polarizer protective film from the extending portion until the polarizer protective film is completely teared off from the polarizer.

8. The method for tearing off the polarizer protective film according to claim 7, wherein the tearing device comprises:
a directional wheel;
a moving wheel that is movable up and down; and
a tape having an adhesive surface, two ends of which are disposed on the directional wheel and the moving wheel, respectively;
wherein the tape is located above the polarizer protective film, and the adhesive surface of the tape faces the polarizer protective film;
before tearing off the polarizer protective film, the adhesive surface of the tape adheres to the polarizer protective film; and
when tearing off the polarizer protective film, the moving wheel rises to drive the tape to move from the extending portion in a direction away from the polarizer protective film in order to completely tear off the polarizer protective film from the polarizer.

9. The method for tearing off the polarizer protective film according to claim 8, wherein the polarizer protective film has one or more corners and the extending portion is connected to one of the corners; and when tearing off the polarizer protective film, the moving wheel rises to drive the tape to move from the corner having the extending portion in a direction away from the polarizer protective film in order to completely tear off the polarizer protective film from the polarizer.

10. The method for tearing off the polarizer protective film according to claim 8, wherein a width of the tape is the same as a width of the extending portion.
